(19) United States
(12) Patent Application Publication
(10) Pub. No.: US 2005/0289398 A1
(43) Pub. Date: Dec. 29, 2005

(54) Testing method and system including processing of simulation data and test patterns

(76) Inventors: Lee Fang Tiw, Gelugor (MY); Khee Lin Lee, Desaria Sungai Ara (MY); Boon Hui Ang, Bukit Mertajam (MY)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 10/875,837

(22) Filed: Jun. 24, 2004

(51) Int. Cl. G06F 11/00

(52) U.S. Cl. 714/39

(57) ABSTRACT

Testing methods and systems including processing of simulation data and test patterns are described herein.

### TECHNICAL FIELD & BACKGROUND

The present disclosure is related generally to the field of microelectronics. More specifically but not exclusively, the present disclosure is related to semiconductor device testing.

A basic test program to be run on an automated test equipment (ATE) includes test patterns or stimuli that specify inputs and expected outputs for the logical functions that a device is expected to perform. In addition, the program includes test flow information as well as test hardware information so that all the necessary voltage levels, waveforms and clock frequencies will be created. Test pattern and test timing information for the program may be derived from a simulated test of a model of the device. Translation from software-modeled simulation tests to test patterns may often be challenging, however, especially for more advanced devices. Because a test pattern is not validated until actual testing by the ATE, it is not always clear whether results are accurate. For example, a failed test may be a result of a physically defective device or test hardware, but it may also be a result of an incorrect test pattern. A time-consuming silicon debug of the device as well as a test pattern debug may then be required to find the cause of the failure.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a flow diagram associated with a semiconductor device testing method according to one embodiment;

FIG. 2 is a flow diagram illustrating an example sequence of events according to one embodiment;

FIG. 3 is signal diagram corresponding to the flow diagram of FIG. 2 according to the embodiment; and

FIG. 4 illustrates a system according to one embodiment.

### DETAILED DESCRIPTION OF ILLUSTRATIVE EMBODIMENTS

Embodiments of the present invention include, but are not limited to, testing methods and systems.

Various aspects of the illustrative embodiments will be described using terms commonly employed by those skilled in the art to convey the substance of their work to others skilled in the art. However, it will be apparent to those skilled in the art that embodiments of the present invention may be practiced with only some of the described aspects. For purposes of explanation, specific numbers, materials and configurations are set forth in order to provide a thorough understanding of the illustrative embodiments. However, it will be apparent to one skilled in the art that embodiments of the present invention may be practiced without the specific details. In other instances, well-known features are omitted or simplified in order not to obscure the illustrative embodiments.

Various operations will be described as multiple discrete operations, in turn, in a manner that is most helpful in understanding embodiments of the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

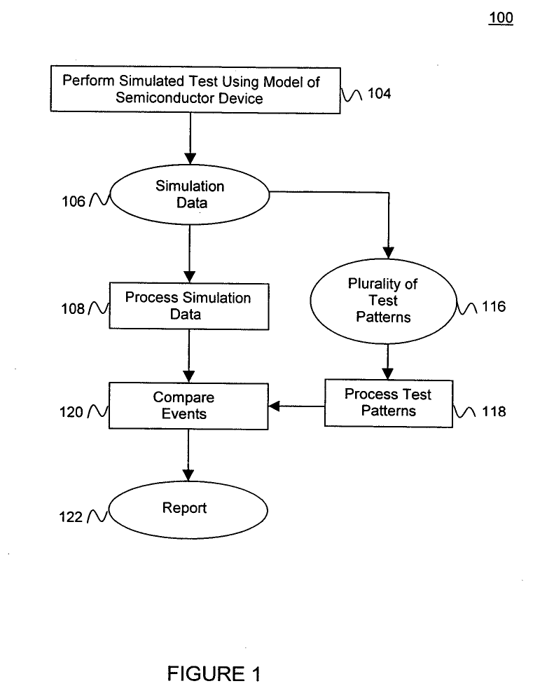

FIG. 1 is a flow chart 100 associated with a testing method that may be used to validate a test pattern according to one embodiment. For the embodiment, beginning at a block 104, a simulated test of a semiconductor device may be performed using a model of the semiconductor device. In one embodiment, the semiconductor device may be designed in a high-level design language such as Verilog® or VHDL (Very High Speed Integrated Circuits Hardware Description Language), and its model may be implemented in a high level language like C. The simulated test may be performed using a simulator such as an Electronic Design Automation (EDA) event-based simulator or other suitable simulation program.

Accordingly, at a next block 106, for the embodiment, simulation data or a simulation trace including the responses of the model to the simulated test may be output. Simulation data from block 106 may then be processed at a block 108 to recover a plurality of trace events that are either drive or strobe events. Additionally, test patterns applied during the simulation to generate the simulation data may also be analyzed in parallel, block 116. Note that in one embodiment, plurality of test patterns from block 116 may have been converted from simulation data by a pattern generation tool or other software to conform to test platform information for an ATE, such as, for example, bus protocols, device function and test vector representation. For the embodiment, the plurality of test patterns from block 116 may then be processed at a block 118 to decode drive or strobe events triggered by the test patterns.

Finally, a comparison may occur at a next block 120, where decoded drive or strobe events (from block 118) may be compared to the recovered plurality of trace events (from block 108) at a plurality of comparison windows. A report may be generated at a block 122 indicating results of the comparison to contribute to a validation of the plurality of test patterns and test timing.

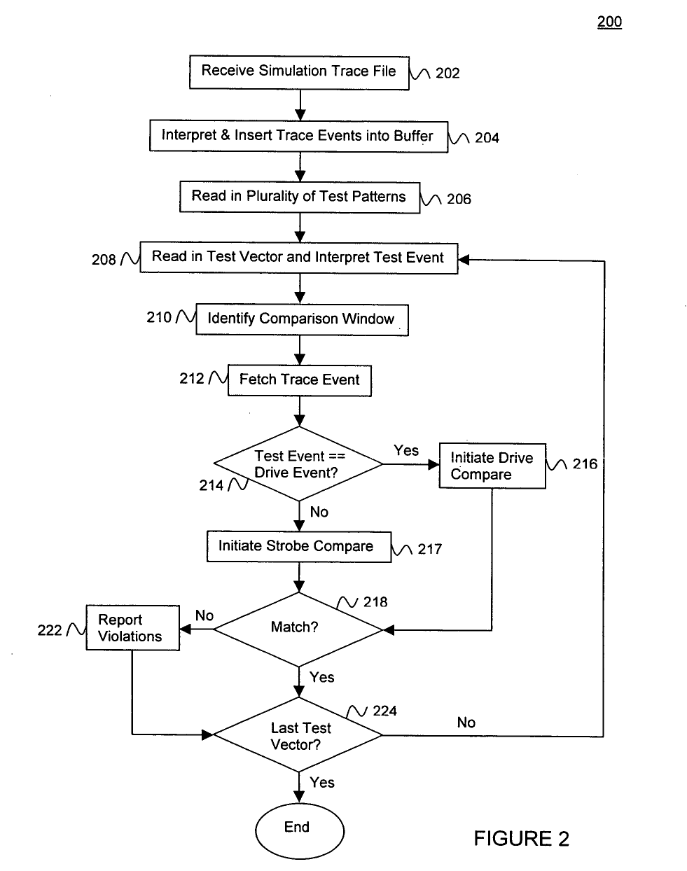

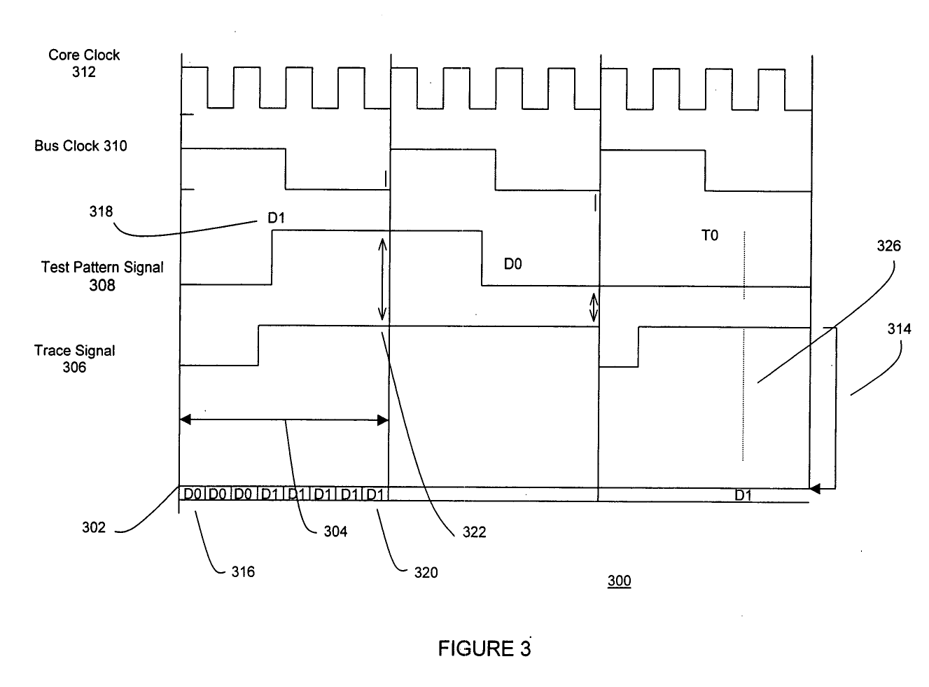

FIG. 2 is a flow diagram 200 illustrating an example sequence of events associated with an embodiment and may be read in conjunction with FIG. 3 which includes a corresponding signal diagram 300. Signal diagram 300 includes a comparison window 304 aligned with a trace buffer 302, a trace signal 306, a test pattern signal 308 and timing signals including bus clock 310 and device core clock 312. Note that algorithms represented by portions of the flow diagram 200 may be implemented by software, software modules, or other machine-readable instructions stored on one or more machine-readable storage media.

Referring now to FIG. 2, where at a beginning block 202, simulation data including a simulation trace file from a simulated test may be received and read. A plurality of trace events that are either drive or strobe events may then be recovered from the simulation trace file and interpreted or decoded into a common state of a drive or strobe event at a block 204. The manner in which the trace events are organized within the simulation trace file is implementation dependent. The trace events may be organized in any one of a number of data organization manners. Similarly, the manner in which drive or strobe events are differentiated is also application dependent, and may be differentiated via any one of a number of techniques. In one embodiment, a common state of a drive or strobe event corresponds to at least one selected from a common state group consisting of a low clock phase state, high clock phase state, high impedance state and an unknown state. For example, common state groups of drive events may be represented as drive low (D0), drive high (D1), drive high-Z (DZ), and drive unknown (DX). Common state groups of a strobe event may be represented as strobe low (T0), strobe high (T1), strobe high-Z (TZ), and strobe unknown (TX).

Continuing to refer to block 204, for the embodiment, each interpreted trace event may then be inserted into a corresponding slot in a trace buffer. To illustrate, signal diagram 300 of FIG. 3 includes arrow 314 leading from trace signal 306 to trace buffer 302. As shown, trace buffer 302 includes interpreted trace events 316 each in a corresponding slot, aligned below trace signal 306. In the embodiment, there may be one trace buffer for each pin signal.

Next, at a block 206, for the embodiment, a plurality of test patterns and test timing may be read in. At a block 208, for the embodiment, a test vector from a test pattern may be read and a test event interpreted into a common state of a drive or strobe event. To illustrate, depicted in FIG. 3 is interpreted test event D1 at 318, triggered by test pattern signal 308. The manner test timing is indicated in a test pattern is also application dependent, and may be expressly or implicitly indicated via any one of a number of techniques.

At a next block 210, a comparison window may be identified so that a test event and corresponding trace event may be compared at the comparison window. In FIG. 3, comparison window 304 is shown aligned with signals of core clock 312 and bus clock 310. In one embodiment, a size of a comparison window 304 may be determined at least partly based on a function of a ratio of the device core clock speed to the front side bus clock speed.

More specifically, in one embodiment, the size of the comparison window may be approximately equal to 2Δ(core clock speed/bus clock speed), where Δ is a fixed time approximately equal to one-half the device core clock speed. In one embodiment, the device core clock speed is approximately the fastest clock speed of the semiconductor device. Thus, in FIG. 3, for example, if the device core clock speed is 5 nanoseconds (ns), Δ may be one-half of this amount, or 2.5 ns. As shown in FIG. 3, if the ratio of the core clock 312 to bus clock 310 is 4, then the size of comparison window 304 may be approximately 2*Δ*ratio=2* 2.5 ns*4=20 ns. For the embodiment, the ratio may be adjusted to identify a comparison window for each pin. In one embodiment, the ratio may be adjusted based on a frequency of a signal waveform. For example, the comparison window may be reduced for a higher frequency of a signal waveform so that a test event is compared with a corresponding trace event. Additionally, in an embodiment, where there is no test event presented in a comparison window, a test event of a previous cycle may be used for comparison with the corresponding trace event.

Next, at a block 212, a trace event referenced by a test event may be fetched from a slot in the trace buffer. At a block 214, if the interpreted test event is a drive event, a drive compare may be initiated at a block 216. In one embodiment, the drive compare may be initiated at an approximate end of a boundary of the identified comparison window. In one embodiment, the drive compare may be initiated at approximately one picosecond before the end of the identified comparison window. Thus, in FIG. 3, a drive compare is initiated at 322 near the end of comparison window 304. Thus, corresponding to the flow in FIG. 2, a match may occur at 322 between test event D1 (drive-high state) and trace event D1 from trace buffer slot 320.

Returning to block 214, where alternately, if the interpreted test event is not a drive event, a strobe compare may be initiated at a block 217. In one embodiment, the comparing of the test event includes initiating a strobe compare at a strobe edge in an identified comparison window. Thus, for example, in FIG. 3, a comparison may occur at strobe edge 326. Note that in various embodiments, comparisons may be initiated at other suitable locations within a comparison window. For example, in one embodiment, a window strobe compare may occur at inner boundary edges of a window strobe. In an embodiment, the window strobe compare may occur at 1 picosecond within each inner boundary edge of the window strobe.

If, after the strobe compare in block 217, the events do not match (e.g. T0 (strobe-low state) and D1 (drive-high state) at 326), a violation may be reported at a block 222. Note that in various embodiments, a bus contention may be detected as a result of test and trace events that do not match. Finally, after a violation is reported, in one embodiment, an inquiry may occur at a next block 224 as to whether the last test vector has been processed. If so, the process may end. If not, the process may return to block 208 to read in another test vector of a test pattern to begin another comparison.

Note that in one embodiment, when a test pattern signal does not include a drive or strobe event for a particular test cycle, the current test pattern cycle may inherit a test event from a previous test pattern cycle. The inherited test event may then be compared to an interpreted trace event from the trace buffer.

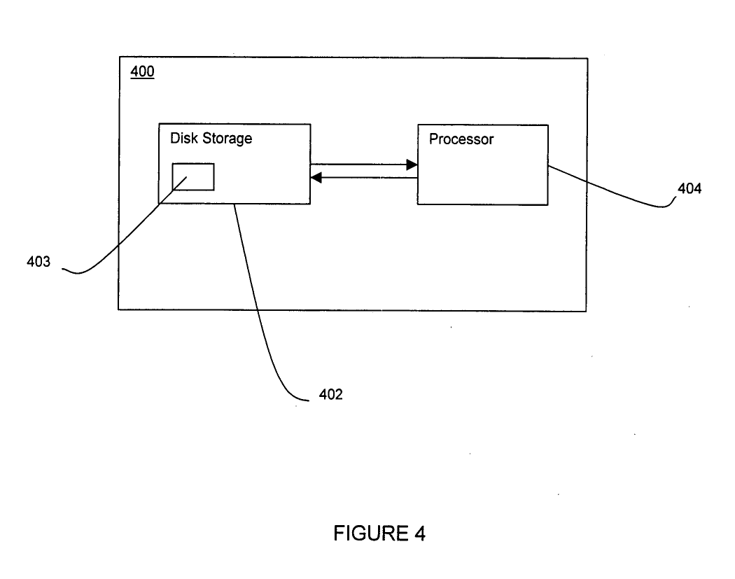

FIG. 4 illustrates an example system, in accordance with one embodiment. For the embodiment, system 400 includes a storage medium such as a disk storage 402 to receive simulation data from a simulated test of a semiconductor device performed using a model of a semiconductor device. As illustrated, disk storage 402 may be coupled to a processor 404. In the embodiment, disk storage 402 may include machine-readable instructions 403, which when executed by processor 404 may cause processor 404 to receive the simulation data and to process the received simulation data to recover a plurality of trace events that are either drive or strobe events. In the embodiment, processor 404 may also process a plurality of test patterns to decode drive or strobe events triggered by the test patterns and compare the decoded drive or strobe events to the recovered events at a plurality of comparison windows. In one embodiment, machine readable instructions 403 includes software having a first, second and third component including the above instructions processed or executed by processor 404.

Thus, it can be seen from the above descriptions, one or more novel methods for test pattern comparison have been described. While the present invention has been described in terms of the foregoing embodiments, those skilled in the art will recognize that the invention is not limited to the embodiments described. Embodiments of the present invention can be practiced with modification and alteration within the spirit and scope of the appended claims. Accordingly, the description is to be regarded as illustrative instead of restrictive on the present invention.

1. A method, comprising:
processing simulation data from a simulated test of a semiconductor device performed using a model of the semiconductor device, to recover a plurality of trace events that are either drive or strobe events;
processing a plurality of test patterns to decode drive or strobe events triggered by the test patterns; and
comparing the decoded drive or strobe events to the recovered events at a plurality of comparison windows.

2. The method of claim 1 wherein the processing of the simulation data further comprises interpreting each of the recovered events into a common state of a drive or strobe event.

3. The method of claim 2 wherein the common state of a drive or strobe event corresponds to at least one selected from a common state group consisting of a low clock phase state, a high clock phase state, a high impedance state, and an unknown state, and the processing of the simulation data further comprises inserting each interpreted event into a slot in a trace buffer.

4. The method of claim 1 wherein the processing of the plurality of test patterns to decode the drive or strobe events includes interpreting each of the drive or strobe events into a common state of a drive or strobe event.

5. The method of claim 1 further comprising identifying each of the plurality of comparison windows

6. The method of claim 5 wherein the identifying of each of the plurality of comparison windows includes determining a size of a comparison window, based at least in part on a function of a core clock speed of the semiconductor device to bus clock speed.

7. The method of claim 6 wherein the determining of a size of the comparison window includes adjusting a ratio based on a frequency of a test pattern signal waveform.

8. The method of claim 5 wherein the comparing of the decoded drive or strobe events to the recovered events includes initiating a drive compare at an approximate end of a boundary of an identified comparison window.

9. The method of claim 8 wherein the initiating of the drive compare at an approximate end of a boundary of the identified comparison window includes initiating the drive compare at approximately 1 picosecond before the approximate end of the identified comparison window.

10. The method of claim 8 wherein the initiating of the drive compare includes initiating the drive compare to detect a bus contention.

11. The method of claim 5 wherein the comparing of the decoded drive or strobe events comprises initiating a strobe compare at a strobe edge in the identified comparison window.

12. An article of manufacture, comprising:
a machine-readable medium having machine-readable instructions stored thereon, which when executed by a processor cause the processor to:
recover a trace event from a simulation trace generated by a simulated test of a semiconductor device performed using a model of a semiconductor device;
decode a test pattern to identify an event triggered by a test pattern;
compare the recovered trace event to the decoded test pattern event at an identified comparison window; and
repeat the recovering, decoding, and comparing.

13. The article of manufacture of claim 12 wherein each of the trace event and the test pattern event is either a drive or strobe event, and the instructions to decode the test pattern include instructions to interpret the test pattern event into a common state of a drive or strobe event.

14. The article of manufacture of claim 13 wherein the instructions to interpret the test pattern event into a common state of a drive or strobe event include instructions to interpret the event into a common state corresponding to at least one selected from a common state group consisting of a low clock phase state, high clock phase state, high impedance state, and an unknown state.

15. The article of manufacture of claim 12 wherein the instructions to recover the trace event further include instructions to interpret the recovered event into a common state of a drive or strobe event.

16. The article of manufacture of claim 12 wherein the instructions to compare the recovered trace event to the decoded test pattern event comprise initiating a strobe compare at a strobe edge in the identified comparison window.

17. The article of manufacture of claim 12 wherein the instructions to compare the recovered trace event to the decoded test pattern event at an identified comparison window include instructions to determine a size of the comparison window based at least in part on a function of a ratio of the core clock speed of the semiconductor device to a front side bus clock speed.

18. An article of manufacture, comprising:
a machine-readable medium having machine-readable instructions stored thereon, which when executed by a processor cause the processor to:
process simulation data from a simulated test of a semiconductor device performed using a model of the semiconductor device, to recover a plurality of trace events that are either drive or strobe events;
process a plurality of test patterns to decode the test patterns and identify drive or strobe events triggered by the test patterns; and
compare the decoded drive or strobe events to the recovered events at a plurality of comparison windows.

19. The article of manufacture of claim 18 wherein the instructions to process the simulation data further include instructions to insert an interpreted drive or strobe event into a trace buffer.

20. The article of manufacture of claim 18 wherein the instructions to compare the decoded drive or strobe events to the recovered events include instructions to initiate a drive compare at an approximate end of a boundary of an identified comparison window.

21. The article of manufacture of claim 20 wherein the instructions to initiate a drive compare at the approximate end of the boundary of the identified comparison window include instructions to initiate the drive compare at approximately 1 picosecond before the approximate end of the identified comparison window.

22. The article of manufacture of claim 18 wherein the instructions to compare the decoded drive or strobe events to the recovered events include instructions to initiate a window strobe compare at inner boundary edges of a window strobe.

23. The article of manufacture of claim 22 wherein the instructions to initiate the window strobe compare include instructions to initiate the window strobe compare at 1 picosecond within each inner boundary edge.

24. The article of manufacture of claim 18 wherein the instructions to compare the decoded drive or strobe events include instructions to compare an inherited test event to an interpreted trace event from a trace buffer.

25. The article of manufacture of claim 24 wherein the inherited test event is inherited from a previous test pattern cycle.

26. A system, comprising:
a disk storage to store simulation data from a simulated test of a semiconductor device performed using a model of a semiconductor device, the disk storage including:
a first, second and third component, having instructions, respectively to:
process the stored simulation data to recover a plurality of trace events that are either drive or strobe events;
process a plurality of test patterns to decode the test patterns to identify drive or strobe events triggered by the test patterns; and
compare the decoded drive or strobe events to the recovered events at a plurality of comparison windows; and
a processor, coupled to the disk storage to:
execute the instructions included in the first, second and third components of the disk storage.

27. The system of claim 26 wherein the disk storage further comprises a buffer to store the plurality of trace events that are either drive or strobe events.

28. The system of claim 26 wherein the first, second, and third components included in the disk storage comprise software.
